(19) United States
(12) Patent Application Publication
(10) Pub. No.: US 2003/0158961 A1
(43) Pub. Date: Aug. 21, 2003

(54) Two-way communication method

(75) Inventors: Yoshihide Nomura, Kawasaki (JP); Hirotaka Hara, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED

(21) Appl. No.: 10/320,347

(22) Filed: Dec. 16, 2002

(30) Foreign Application Priority Data
Dec. 17, 2001 (JP) 2001-383324(PAT.
Dec. 2, 2002 (JP) 2002-350379(PAT.

(51) Int. Cl. H04L 9/00; G06F 15/16

(52) U.S. Cl. 709/237; 713/155

(57) ABSTRACT

A system using only one-way request/response type synchronous communication from a request side 11, wherein a message is transmitted from a response side 12 to the request side 11 by having the request side request reception of the message and having the response side continue to transmit the same message including a signature and ID to the request side until the request side notifies the response side that it has received the message by new communication, whereby two-way acknowledgment of transmission is made possible by one-way communication protocol, denial of the fact of transfer is prevented, and automation of processing for guaranteeing uniqueness of a message is facilitated.

### BACKGROUND OF THE INVENTION

1. Field of the Invention

The present invention relates to a two-way communication method, more particularly relates to a two-way communication method in a system using only request/response type synchronous communication where a request side makes a one-way request to a response side and the response side responds to the request to the request side, which method enables transfer of messages in two directions, guarantee of the reliability, and prevention of denial of transfer (nonrepudiation).

2. Description of the Related Art

FIG. 1 is a block diagram of the configuration of a conventional system using only request/response type synchronous communication. In the figure, reference numeral 11 is a request side client, 12 is a response side server, and 13 is a firewall provided at the entrance of the client 11. If the firewall 13 is provided in this way, communication between the inside and outside often is performed using one-way request/response type synchronous communication.

If using only one-way request/response type synchronous communication, with the conventional HTTP and other protocol, as shown in FIG. 1, message transmission and acknowledgment can only be realized one-way from the request side 11 to the response side 12. Even if trying to transmit a message from the server side 12 to the client side 11, this is blocked by the firewall 13, so there is the problem that the message will not reach the client side 11.

Further, with just presenting the record of transfer to the other side, there is no proof of actual transfer. Therefore, there is the problem that the receiving side can deny the fact of transmission or the transmitting side can deny the fact of reception (repudiation). This denial of the fact of transmission or denial of the fact of reception is particularly serious in the case of monetary transactions conducted through the Internet.

### SUMMARY OF THE INVENTION

An object of the present invention, in consideration of the problems in the prior art, is to provide a communication method enabling two-way acknowledgment of transmission by a later explained retransmission routine using a one-way request/response type communications protocol.

Another object of the present invention is to provide the above communication method which further adds unique identifiers to messages and prepares signatures for transferred messages and exchanges the same so as to leave proof that transfer was reliably performed and thereby prevent denial of the fact of transmission or the fact of reception (nonrepudiation).

Still another object of the present invention is to facilitate automation of processing for guaranteeing the uniqueness of a message by constructing a message using the XML (Extensive Markup Language).

To achieve the above objects, according to a first aspect of the present invention, there is provided a two-way communication method comprising transmitting a message from a response side to a request side by having the request side request reception of the message and having the response side continue to transmit the same message to the request side until the request side notifies the response side that it has received the message by new communication and thereby enabling two-way transfer of messages.

If responding to a request for reception from the request side, the response side can transmit the message to the request side, so messages can be transmitted from both the request side and response side.

According to a second aspect of the present invention, there is provided the first aspect further comprising adding a unique identifier to the inside of the transmission message and checking for duplication at the receiving side so as to prevent the same message from being received in duplicate.

According to a third aspect of the present invention, there is provided the second aspect further comprising using XML for the format of the message and adding an identifier inside the message by a specific name space different from the message so as to prevent the same message from being received in duplicate without changing the format of the message.

According to a fourth aspect of the present invention, there is provided the first aspect further comprising realizing the uniqueness of the message by any form and using a digest value of the message at the time of verification of the uniqueness of the message to prevent the same message from being received in duplicate.

According to the second to fourth aspects of the invention, it is possible to prevent the same message from being received in duplicate, so it is possible to improve the communication efficiency.

According to a fifth aspect of the present invention, there is provided any one of the second to fourth aspects further employing at least one of the fact that by adding a transmission message use electronic signature to a message transmitted by a transmission side of a message and having that transmission message use signature stored by the receiving side, it is possible to prevent denial by the transmission side of the fact of transmission and the fact that by adding a reception message use electronic signature to a reception notification of a message transmitted by the receiving side of the message in response to reception of the message and having that reception notification use electronic signature stored by the transmitting side, it is possible to prevent denial of the fact of reception by the receiving side.

Due to this, it is possible to prevent denial of the fact of transmission by the transmitting side and denial of the fact of reception by the receiving side.

### BRIEF DESCRIPTION OF THE DRAWINGS

FIG. 1 is a block diagram of the configuration of a conventional system using only request/response type synchronous communication.

FIG. 2 is a block diagram of the flow of data in the case of transmission of a message from a request side to a response side according to a first embodiment of the present invention.

FIG. 3 is a flow chart for explaining the flow of processing when transmitting the message shown in FIG. 2.

FIG. 4 is a block diagram of the flow of data when enabling two-way communication according to the first embodiment of the present invention.

FIG. 5 is a flow chart for explaining the flow of processing when transmitting the message shown in FIG. 4.

FIG. 6 is a view for explaining burial of an identifier (ID) of a message in a specific location in a set format in a message according to a second embodiment of the present invention.

FIG. 7 is a view for explaining the method of burial of a message ID in a message at a name space different from the message content according to a third embodiment of the present invention.

FIG. 8 is a view for explaining the method for verifying the uniqueness of a message utilizing a digest of the message according to a fourth embodiment of the present invention.

FIG. 9 is a block diagram for explaining the flow of data in the method of preventing the fact of transmission by a transmitted being later denied by the transmitter according to a fifth embodiment of the present invention.

FIG. 10 is a flow chart for explaining the flow of processing for preventing denial of the fact of transmission by the transmitter when transmitting a message from the request side 11 to the response side 12 in the system shown in FIG. 9.

FIGS. 11A and 11B are parts of a flow chart for explaining the flow of processing for preventing denial of the fact of transmission by a transmitter when transmitting a message from a response side 12 to a request side 11.

FIG. 12 is a block diagram for explaining the flow of data in a method for preventing later denial by a receiver of the fact of reception by the receiver according to a sixth embodiment of the present invention.

FIG. 13 is a flow chart for explaining the flow of processing for preventing denial of the fact of reception by a receiver when transmitting a message from a request side 11 to a response side 12.

FIGS. 14A and 14B are parts of a flow chart for explaining the flow of processing for preventing denial of the fact of reception by a receiver when transmitting a message from a response side 12 to a request side 11.

FIG. 15 is a block diagram for explaining the flow of data in a method of preventing later denial by a transferrer of the fact of transfer by the transferrer according to a seventh embodiment of the present invention.

FIGS. 16A and 16B are parts of a flow chart for explaining the flow of processing when transmitting a message from a request side 11 to a response side 12.

FIGS. 17A and 17B are parts of a flow chart for explaining the flow of processing for preventing denial of the fact of transfer by a transferrer when transmitting a message from a response side 12 to a request side 11.

FIG. 18 is a flow chart for explaining the method of storage of a message according to an eighth embodiment of the present invention when a message fails to be stored at step S37 in FIG. 3 or step S60 in FIG. 5.

FIG. 19 is a flow chart for explaining the method of storage of a message and signature according to a ninth embodiment of the present invention when a message and signature fail to be stored at step S201 in FIG. 16B or step S233 in FIG. 7A.

FIG. 20 is a view of an example of the content of a message when a request side requests transmission of a message to a response side.

FIG. 21 is a view of an example of an unsigned transmission message.

FIG. 22 is a view of an example of an unsigned reception acknowledgment message.

FIG. 23 is a view of a part of an example of a signed transmission acknowledgment message.

FIG. 24 is a view of another part of a signed transmission acknowledgment message.

FIG. 25 is a view of still another part of a signed transmission acknowledgment message.

FIG. 26 is a view of a part of an example of a signed reception acknowledgment message.

FIG. 27 is a view of another part of a signed reception acknowledgment message.

FIG. 28 is a view of still another part of a signed reception acknowledgment message.

### DESCRIPTION OF THE PREFERRED EMBODIMENTS

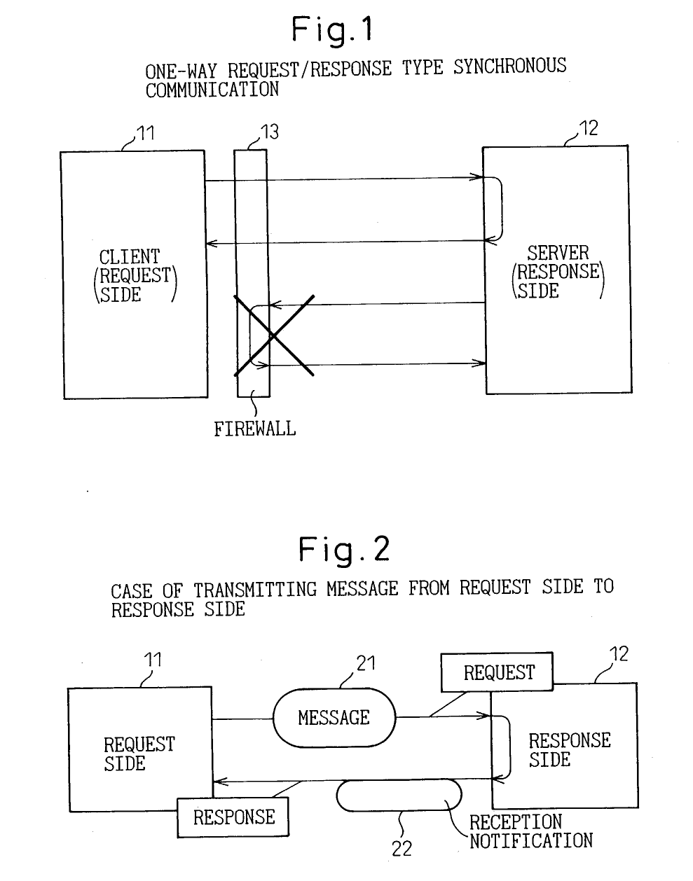

Next, embodiments of the present invention will be described while referring to the attached figures. In the following explanation, the same reference numerals express the same elements. The firewall 13 shown in FIG. 1 is not illustrated in other figures for simplification.

FIG. 2 is a block diagram of the flow of data when transmitting a message from a request side 11 to a response side 12 according to a first embodiment of the present invention. As an example of the request side 11, there is a seller or buyer of a product or other client not having a server. As an example of the response side 12, there is a server performing the role of a center storing application forms etc. in a database.

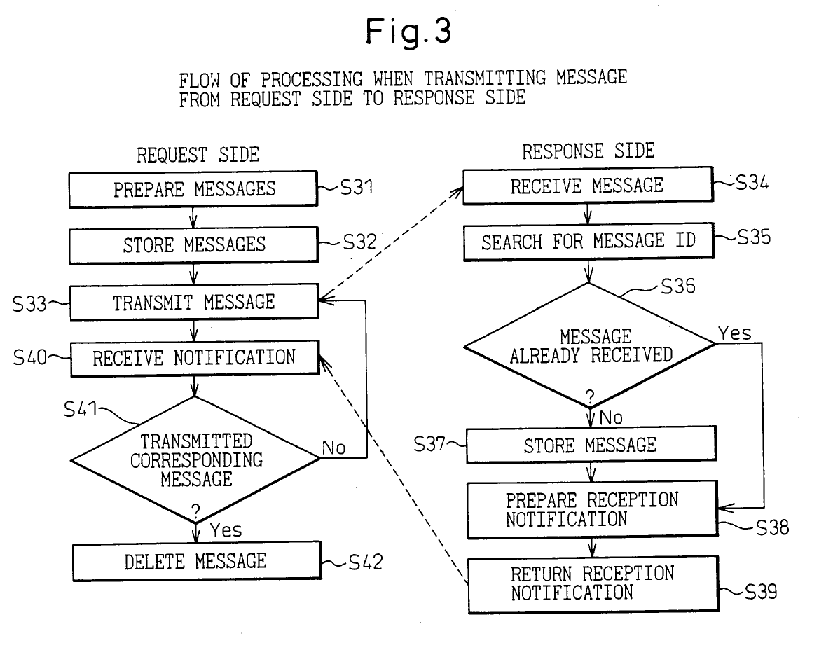

FIG. 3 is a flow chart for explaining the flow of processing when transmitting the message shown in FIG. 2.

The transmission of the message explained in FIG. 2 and FIG. 3 is itself performed by conventional one-way communication.

In FIG. 2 and FIG. 3, the request side 11 prepares one or more messages at step S31, stores the messages at step S32, then transmits the message 21 desired to be sent to the response side 12 at step S33. The message 21 includes a request for return of a reception notification.

The response side 12 receives the message at step S34 and searches for whether there is the same ID as the ID in the message received at the response side 12 at step S35. If the result of the search is that there is no same ID at the response side 12 at step S36, the currently received message is a new message, so the received message is stored at step S37 and a reception notification is prepared at step S38. If the result of the search at step S36 is that there is the same ID at the response side 12, the message has already been received, so the currently received message is not stored and a reception notification is prepared at step S38. Next, a reception notification 22 is returned toward the request side 11 at step S39. The reception notification 22 includes information indicating that it is a response to a request.

The request side 11 monitors for reception of the reception notification 22 every predetermined time interval at step S40 and judges at step S41 whether it has transmitted the corresponding message, that is, whether the message transmitted from the request side 11 at step S33 has been normally received by the response side 12, by the existence of the reception notification 22. If still not receiving the reception notification 22, it judges that it has not transmitted the corresponding message 21, returns to step S33, and resends the message 21 to the response side 12.

When it is judged at step S41 that the message 21 has finished being transmitted, at step S42, the request side deletes the corresponding message 21 stored at it.

The one-way transmission of the message from the request side 11 to the response side 12 explained by FIG. 2 and FIG. 3 is possible in the same way as the past.

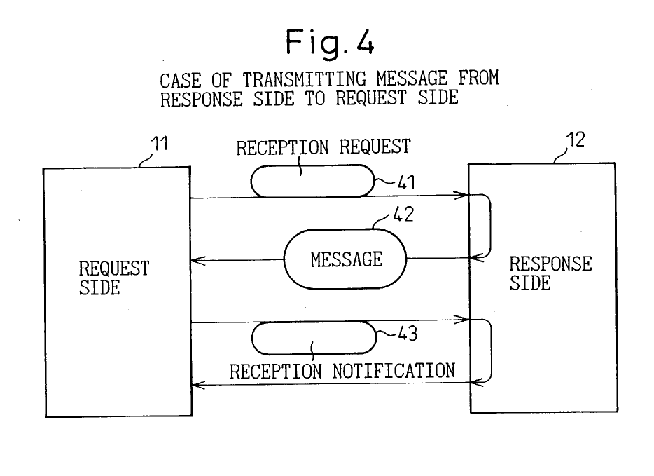

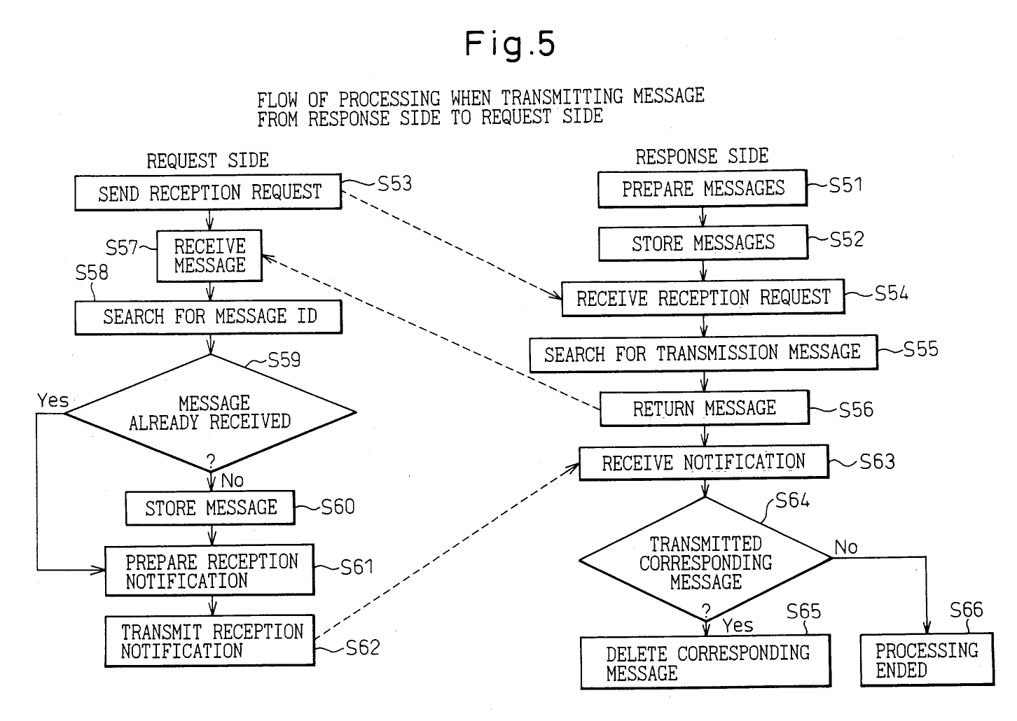

FIG. 4 is a block diagram showing the flow of data when enabling two-way communication according to the first embodiment of the present invention, while FIG. 5 is a flow chart explaining the flow of processing when transmitting the message shown in FIG. 4.

In FIG. 4 and FIG. 5, the response side 12 prepares one or more messages at step S51 and stores the messages at step S52.

The request side 11 transmits a reception request 41 to the response side 12 at step S53. The response side 12 receives this reception request 41 at step S54, then searches for the message 42 corresponding to the reception request from the stored messages at step S55. If there is a message 42 corresponding to the reception request, the response side 12 transmits that message 42 to the request side 11 at step S56.

The request side 11 receives the message 42 at step S57 and searches for whether there is the same ID as the ID in the message received at step S58 at the request side 11. If the result of the search is that there is no same ID at the request side 11, the currently received message is a new message, so the received message is stored at step S60 and a reception notification 43 is prepared at step S61. If the result of the search at step S59 is that there is the same ID at the request side 11, the message has already been received, so the currently received message is not stored and a reception notification 43 is prepared at step S61. Next, a reception notification 43 is returned toward the response side 12 at step S62.

The response side 12 monitors for reception of the reception notification 43 every predetermined time interval at step S63 and judges at step S64 whether it has transmitted the corresponding message, that is, whether the message returned from the response side 12 at step S63 has been normally received by the request side 11, by the existence of the reception notification 43. If receiving the reception notification 43, it is judged that the message 42 has finished being transmitted from the request side 11 to the response side 12 and the message 42 corresponding to the reception request 41 stored at the response side 12 is deleted at step S65.

When the reception notification 43 has not been received, the processing ends at step S66.

The reception request 41 is periodically transmitted from the request side 11 to the response side 12, so the message 42 is periodically repeatedly transmitted until the reception notification 43 arrives from the request side 11. If the reception notification 43 is not transmitted from the request side 11, the response side 12 does not know if the message 42 has indeed reached the request side 11, but according to this embodiment of the present invention, the reception notification 43 is returned from the request side 11 to the response side 12 in response to the reception of the message 42, so the response side 12 can determine reliably that the message 42 has reached the request side and as a result two-way delivery of messages becomes possible.

In this way, in a system able to send a message to the outside from just the request side 11 due to a firewall provided at the request side 11, there is a particular need for transmitting a message from the response side 12 to the request side 11 and need for being able to determine if a message sent from the response side 12 has reliably been received at the request side 11 in communications relating to finance, communication of documents between clients inside a company and other companies outside, types of application forms issued by the response side 12, etc. For example, there are requests for including messages in a screen of a web browser sent from a response side 12 such as for distribution of application forms. In the past, in this case, it was not possible to distribute messages from the response side 12 to the request side 11, but according to this embodiment of the present invention, it becomes possible to distribute messages reliably in the above way from the response side 12 to the request side 11.

Further, transfer of messages can be realized using SOAP (simple object access protocol) and other protocol.

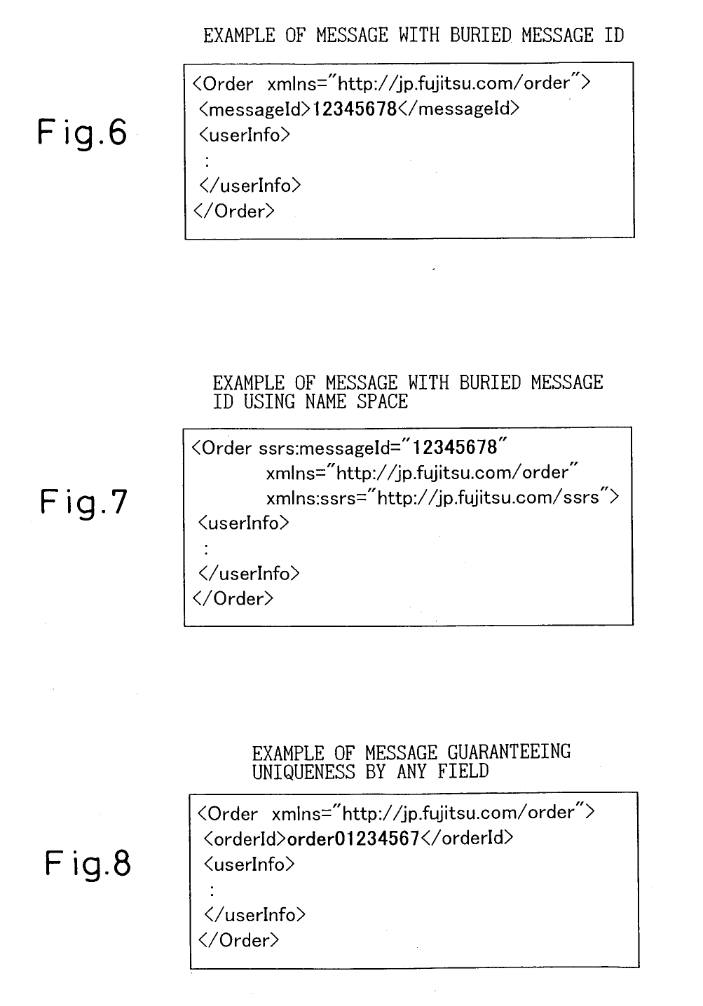

FIG. 6 is a view explaining the method of burying an identifier (ID) of a message at a specific location in the predetermined format of the message according to a second embodiment of the present invention. In the figure, the portion from the route tag <Order> to the route tag </Order> is a message of an order of a fixed format. “12345678” is buried as an ID between the two “messageId” tags in the message. The receiving side knows the format of the message, so compares the ID in the received message with the IDs it holds to judge if the message has already been received. The illustrated example shows a message of an order described by XML, but any language may be used for the message so long as it is a fixed format. Due to this, it becomes possible for the receiving side to search for message IDs from a program analyzable format.

FIG. 7 is a view explaining the method of burying a message ID in a name space separate from the message content in the message according to a third embodiment of the present invention. In the figure, the portion from the route tag <Order> to the route tag </Order> is a message of an order in the same way as in FIG. 6, but the message ID of =“12345678” is buried after the prefix ssrs: in the message and the subsequent attribute name “messageId”. Due to this, the receiving side can search for the attribute of the prefix by a program to find the ID and verify the uniqueness of the message.

In the example of FIG. 7, <Order> is used as the route tag, but it is possible to bury the message ID after the prefix and attribute ssrs:messageID=, so the ID can be found regardless of what the route tag is. Further, the message can be of any format.

FIG. 8 is a view for explaining the method of verification of the uniqueness of a message using the digest of a message according to a fourth embodiment of the present invention. In this case, a code including the ID of <orderId> order012345678</orderId> is inserted at any location in the message from the route tag <Order> to the route tag </Order>, then the message is compressed to a digest and transmitted according to the SHA1, MD5, or other algorithm. The receiving side processes this digest using a predetermined algorithm. If either the content or ID of the received message differs from the content or ID of an already received message, the processed values of the digests will also differ. If both the content and ID of the received message match with the content and ID of an already received message, the processed values of the digests will also match. Due to this as well, it becomes possible to verify the uniqueness of the received message. In FIG. 8 as well, the message is not limited to an order and can be of any content. Further, the message may be of any format.

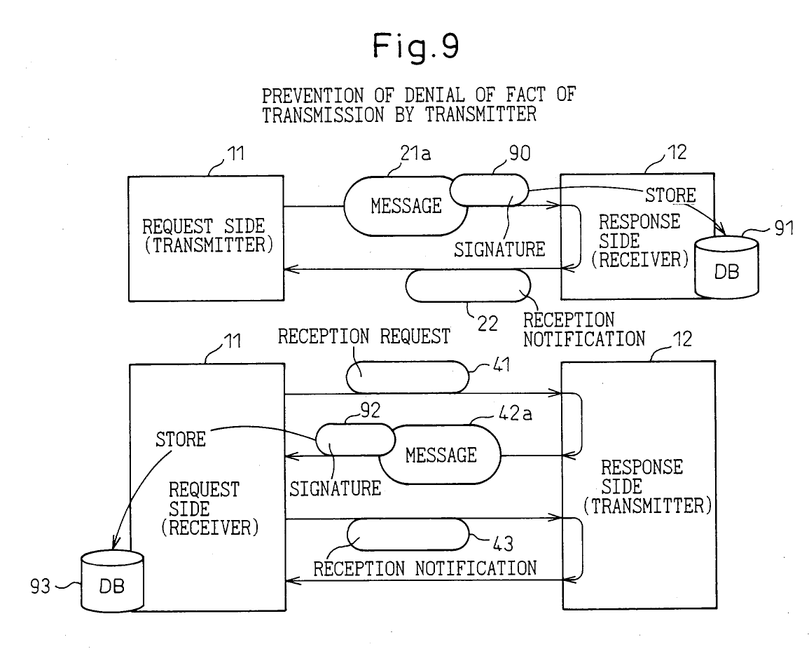

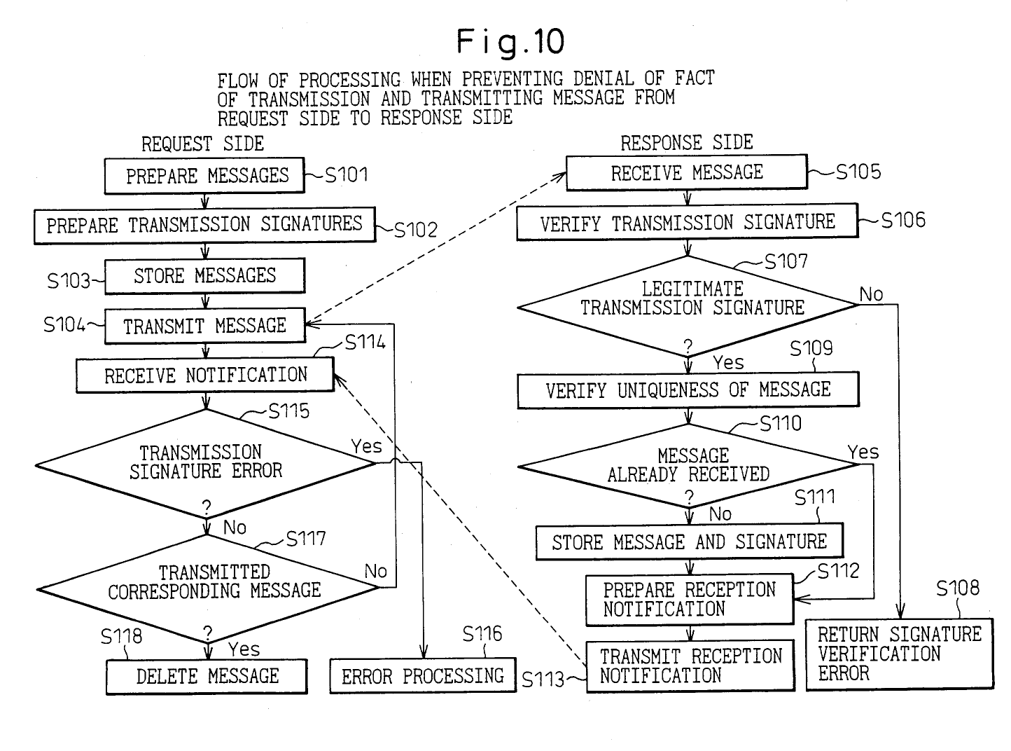

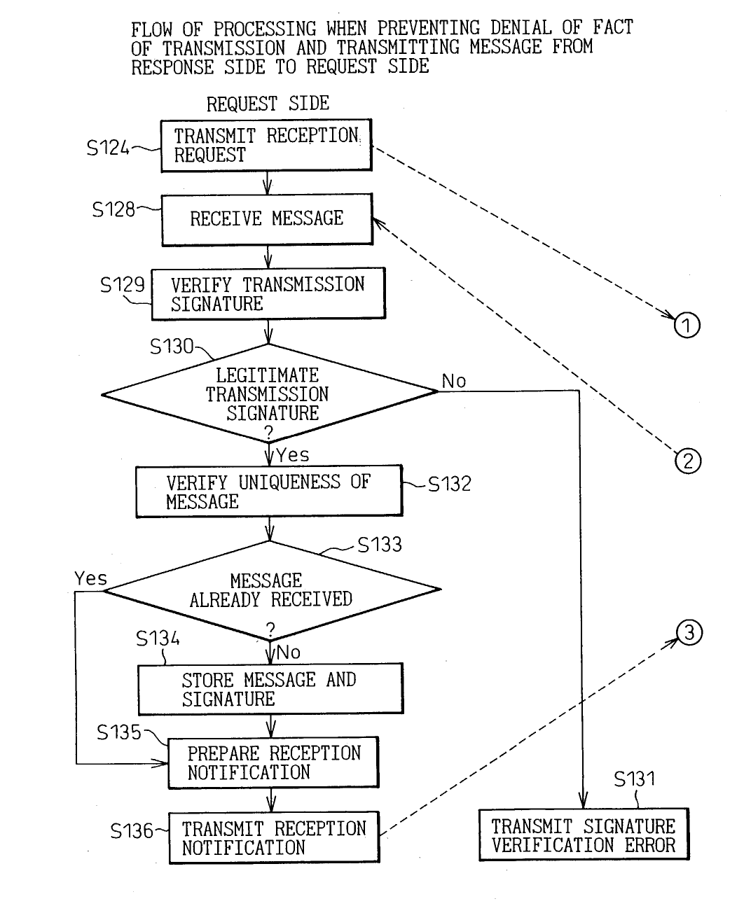

FIG. 9 is a block diagram for explaining the flow of data in a method of preventing a transmitter from later denying the fact of transmission by the transmitter according to a fifth embodiment of the present invention. FIG. 10 is a flow chart for explaining the flow of processing for preventing denial by a transmitter of the fact of transmission when transmitting a message from the request side 11 to the response side 12 in the system shown in FIG. 9.

The difference between FIG. 10 and FIG. 3 is that additionally, in FIG. 10, the request side 11 prepares a transmission signature at step S102, while the response side 12 verifies the transmission signature at step S106 and step S107, stores the signature in addition to the message at step S111, and judges if a transmission signature error has been returned at step S115.

More specifically, in FIG. 9 and FIG. 10, the request side 11 prepares one or more messages at step S101, prepares transmission signatures able to be prepared by only the transmitters at step S102, stores the signatures together with the messages at step S103, and transmits the message 21a desired to be transmitted to the response side 12 at step S104. The message 21 includes a request for return of a reception notification and a signature.

The response side 12 receives the message at step S105 and verifies the transmission signature by an open key of the transmitter at step S106. If the result of the verification at step S107 is that the signature is not legitimate, the routine proceeds to step S108, where a signature verification error is placed in the reception notification 22 and returned to the request side 11. If the result of verification of the signature is that it is legitimate at step S107, the routine proceeds to step S109, where either of the methods of FIG. 6 to FIG. 8 is used to search for the same ID as the ID in the received message at the response side 12. If the result of the search is that there is no same ID at the response side 12 at step S110, the currently received message is a new message, so the received message and the signature 90 of the transmitter are stored in a database 91 at step S111 and a reception notification is prepared at step S112. If the result of the search at step S110 is that the received message is present at the response side 12, the message has already been received, so the currently received message is not stored and a reception notification is prepared at step S112. Next, at step S113, the reception notification 22 is returned to the request side 11. This reception notification 22 includes information to the effect that it is a response to a request.

The request side 11 monitors for reception of the above reception notification 22 every predetermined time interval at step S114, judges if a transmission signature error has been returned at step S115, and performs error processing if a transmission signature error is returned at step S116.

When the judgment at step S115 is that there is no transmission signature error, the routine proceeds to step S117, where the request side 11 judges if the corresponding message has been transmitted and normally received, that is, if the message transmitted from the request side 11 at step S104 has been received by the response side 12, by the existence of the reception notification 22. If the reception notification 22 has not yet been received, it judges that the corresponding message 21a has not been transmitted and returns to step S104 where it resends the message 21a to the response side 12.

When the judgment at step S117 is that the message 21a has finished being transmitted, the request side 11 deletes the corresponding message 21 it has stored at step S118.

Due to this, even if the request side 11 denies the fact of transmission, the database 91 of the response side 12 stores a signature only able to be prepared by the request side 11, so the denial of the fact of transmission by the request side 11 can be rejected by the response side 12.

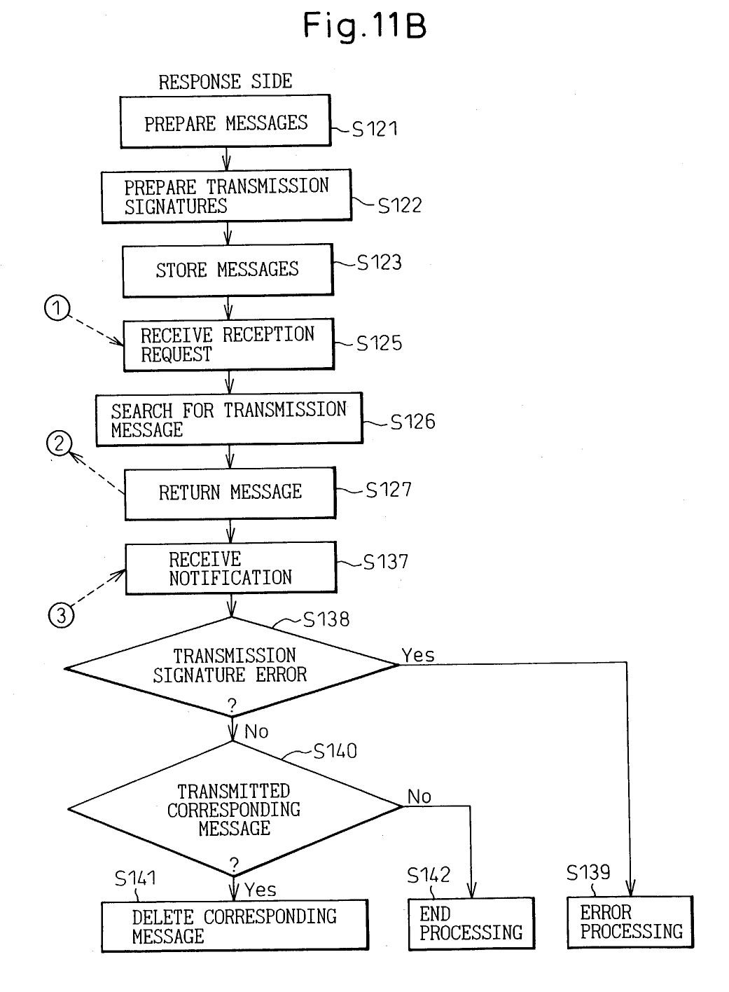

FIGS. 11A and 11B are flow charts for explaining the flow of processing for preventing denial by the transmitter of the fact of transmission when transmitting a message from the response side 12 to the request side 11 in the system shown in FIG. 9.

The difference between FIGS. 11A and 11B and FIG. 5 is that additionally, in FIGS. 11A and 11B, the response side 12 prepares a transmission signature at step S122, the request side 11 verifies the transmission signature at step S129, step S130, and step S131, and stores the signature in addition to the message at step S134, and the response side 12 judges if there is a transmission signature error at step S138 and step S139.

More specifically, in FIG. 9 and FIGS. 11A and 11B, the response side 12 prepares one or more messages at step S121 and prepares transmission signatures able to be prepared only by the transmitter at step S122. Next, it stores the transmission signatures together with the messages at step S123.

The request side 11 transmits a reception request 41 to the response side 12 at step S124. The response side 12 receives the reception request 41 at step S125 and searches for a message 42 corresponding to that reception request from the stored messages at step S126. If there is a message 42a corresponding to the reception request, it transmits that message 42a to the request side 11 together with the signature 92 at step S127.

The request side 11 receives the message 42a at step S128, then verifies whether the transmission signature in the message received is legitimate or not by an open key of the transmitter at step S129. If not legitimate, it returns a signature verification error to the response side 12 at step S131. If legitimate, it searches whether there is the same ID as the ID in the received message at the request side 11 at step S132 and step S133. If the result of the search is that there is no same ID at the response side 12, the currently received message is a new message, so the request side 11 stores the received message together with the signature 92 in the database 93 at step S134 and prepares a reception notification 43 at step S135. If the result of the search at step S133 is that the same ID is present at the request side 11, the message has already been received, so the currently received message is not stored and a reception notification 43 is prepared at step S135. Next, the request side 11 returns the reception notification to the response side 12 at step 136.

The response side 12 monitors for reception of the reception notification 43 every predetermined time interval at step S137 and judges if there is a transmission signature error at step S138. If there is an error, it performs error processing at step S139. If there is no error, it proceeds to step S140, where it judges if it has transmitted the corresponding message, that is, if the message returned from the response side 12 at step S127 has been normally received by the request side 11, by the existence of the reception notification 43. If judging that the message 42a has finished being transmitted, the response side 12 deletes the corresponding message 42a it has stored at step S141.

When not yet receiving the reception notification 43, the processing ends at step S142.

Due to this, even if the response side 11 denies the fact of transmission, the database 92 of the request side 11 stores the signature 92 only able to be prepared by the response side 12, so the denial by the response side 12 of the fact of transmission can be rejected by the request side 11.

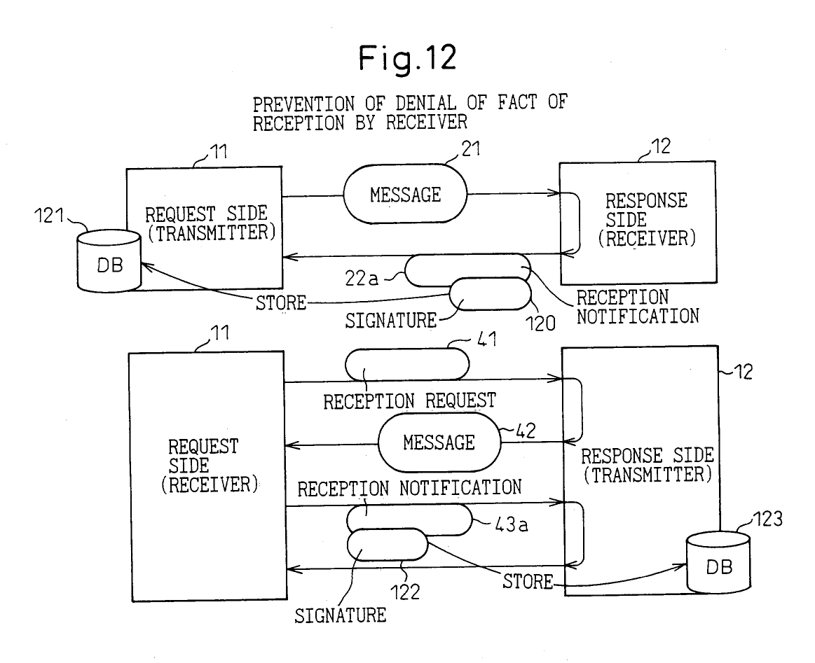

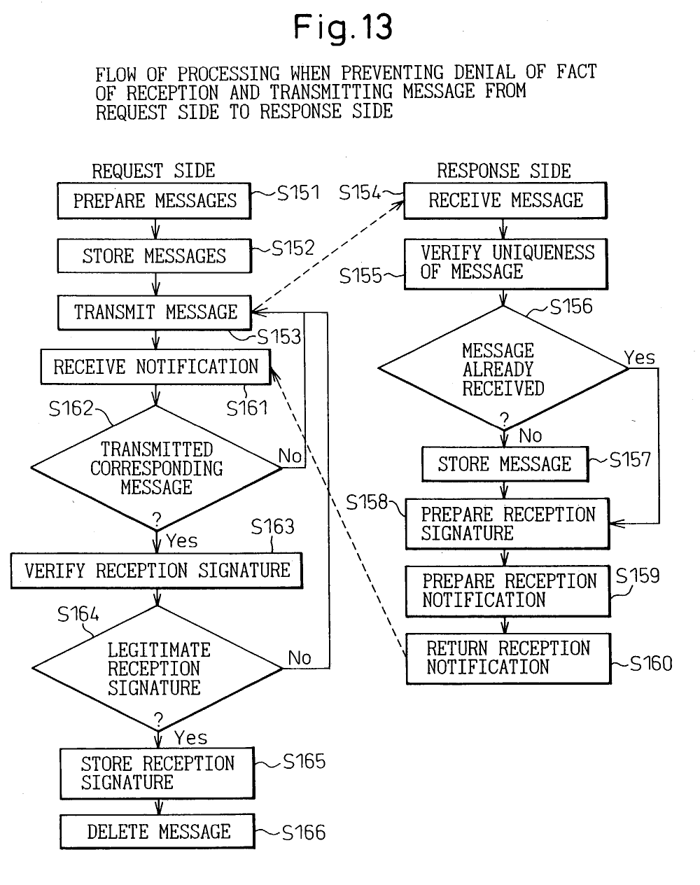

FIG. 12 is a block diagram for explaining the flow of data in the method of preventing later denial by a receiver of the fact of reception by the receiver according to a sixth embodiment of the present invention, while FIG. 13 is a flow chart for explaining the flow of processing for preventing denial by a receiver of the fact of reception when transmitting a message from the request side 11 to the response side 12 in the system shown in FIG. 12.

The difference between FIG. 13 and FIG. 3 is that additionally, in FIG. 13, the response side 12 prepares a reception signature at step S158, while the request side 11 verifies the reception signature at step S163 and step S164 and stores the reception signature at step S165.

More specifically, in FIG. 12 and FIG. 13, the request side 11 prepares one or more messages at step S151, stores the messages at step S152, and transmits the message 21 desired to be sent to the response side 12 at step S153. The message 21 contains a request for return of a reception notification.

The response side 12 receives the message at step S154 and uses any of the methods of FIG. 6 to FIG. 8 to verify if there is the same ID as the ID in the received message at the response side 12 at step S155. If the result of the verification is that there is no same ID at the response side at step S156, the currently received message is a new message, so the response side 12 stores the received message at step S157 and prepares a reception signature 120 able to be prepared only by a receiver at step S158. If the result of the judgment at step S156 is that the same ID is present at the response side 12, the message has already been received, so the currently received message is not stored and a reception notification is prepared at step S159. Next, the response side 12 returns a reception notification 22a to the request side 11 at step S160. The reception notification 22a includes a reception signature 120 in addition to information to the effect that it is a response to a request.

The request side 11 monitors for reception of the above reception notification 22 every predetermined time interval at step S161 and judges at step S162 whether it has transmitted the corresponding message, that is, whether the message transmitted from the request side 11 at step S153 has been normally received by the response side 12, by the existence of the reception notification 22a. If still not receiving the reception notification 22a, it judges that it has not transmitted the corresponding message 21, returns to step S153, and resends the message 21 to the response side 12.

When it is judged at step S164 that the message 21 has finished being transmitted, at step S165, the request side 11 adds the reception signature to the database 121 at step S165, then deletes the corresponding message 21 stored at it at step S166.

Due to this, even if the response side 12 denies the fact of reception, the database 121 of the request side 11 stores the signature able to be prepared only by the response side 12, so the denial of the fact of reception by the response side 12 can be rejected by the request side 11.

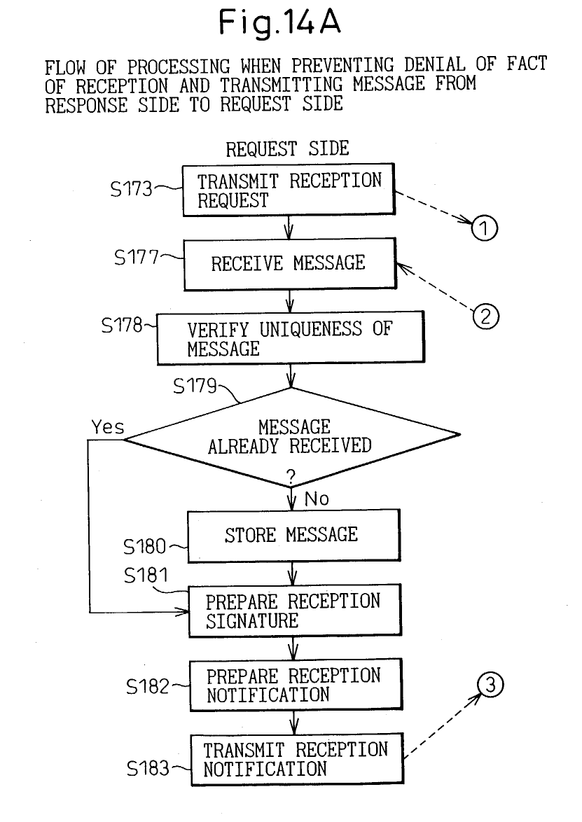

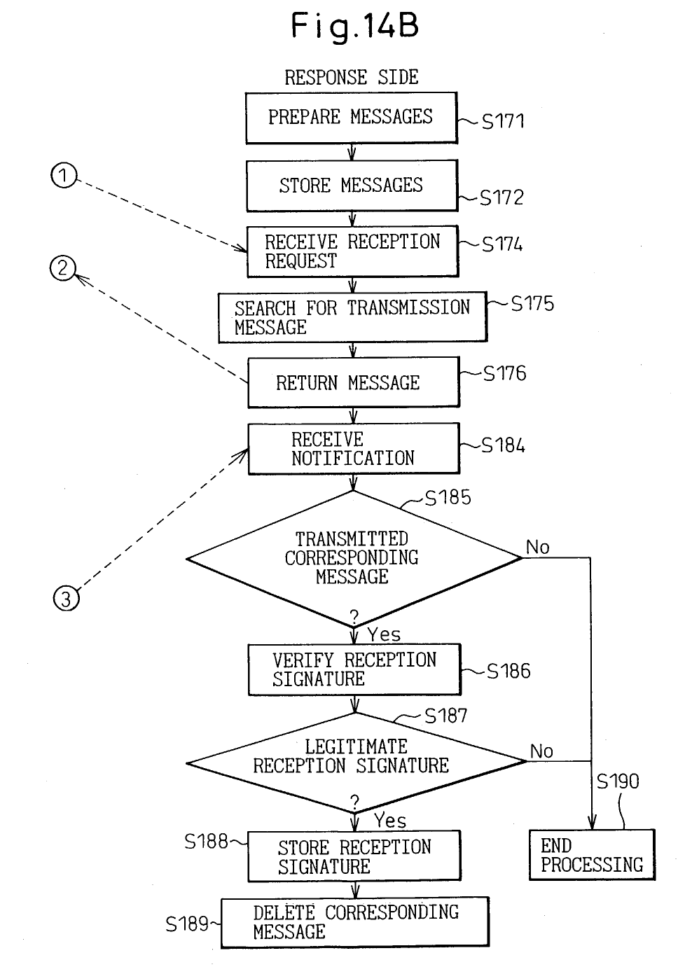

FIGS. 14A and 14B are parts of a flow chart for explaining the flow of processing for preventing denial by a receiver of the fact of reception when transmitting a message from the response side 12 to the request side 11 in the system shown in FIG. 12.

The difference between FIGS. 14A and 14B and FIG. 5 is that, in FIGS. 14, the request side 11 prepares a reception signature at step S181, while the response side 12 verifies the transmission signature at step S186 and step 187 and stores the reception signature at step S188.

More specifically, in FIG. 12 and FIGS. 14A and 14B, the response side 12 prepares one or more messages at step S171 and stores the messages at step S172.

The request side 11 transmits a reception request 41 to the response side 12 at step S173. The response side 12 receives this reception request 41 at step S174 and searches for the message 42 corresponding to the reception request from the stored messages at step S175. If the message 42 corresponding to the reception request is present, it transmits the message 42 to the request side 11 at step S176.

The request side 11 receives the message 42 at step S177 and verifies if there is the same ID as the ID of the message received at the request side 11 at step S178. If the result of the verification is that there is no same ID at the response side 12 at step S179, the currently received message is a new message, so the request side 11 stores the received message at step S180, prepares a reception signature 122 able to be prepared only by a receiver at step S181, and prepares a reception notification 43a including the reception signature 122 at step S184. If the result of the search at step S179 is that there is the same ID in the request side 11, the message has already been received, so the currently received message is not stored, a reception signature 122 able to be prepared only by a receiver is prepared at step S181, and a reception notification 43a including the reception signature 122 is prepared at step S184. Next, the request side 11 returns the reception notification 43a to the response side 12 at step S183.

The response side 12 monitors for reception of the reception notification 43a every predetermined time interval at step S184 and judges at step S185 whether it has transmitted the corresponding message, that is, whether the message transmitted from the response side 12 at step S176 has been normally received by the request side 11, by the existence of the reception notification 43a. If judging that the message 42 has finished being transmitted, the response side 12 verifies the reception signature by the open key of the receiver at step S186. If it is judged by the judgment of step S187 that the reception signature is legitimate, the response side 12 stores the reception signal in the database 123 at step S188 and deletes the corresponding message 42 stored at it at step S189.

If the judgment at step S185 is that the reception notification 43 has not yet been received or if the judgment at step S187 is that the reception signature is not legitimate, the processing ends at step S190.

Due to this, even if the request side 11 denies the fact of reception, the database 123 of the response side 12 stores the reception signature 132 able to be prepared only by the request side 11, so the denial by the request side 11 of the fact of reception can be rejected by the response side 12.

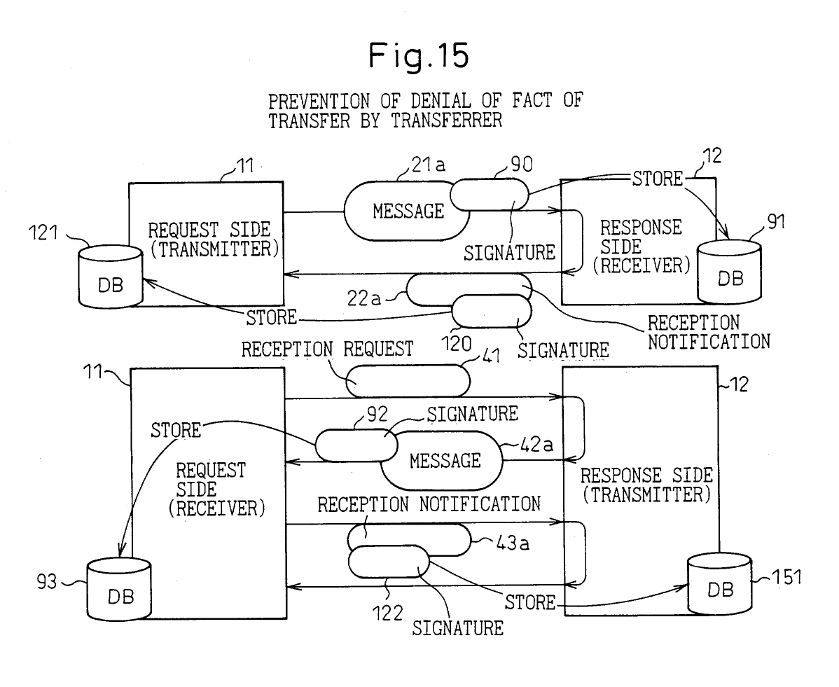

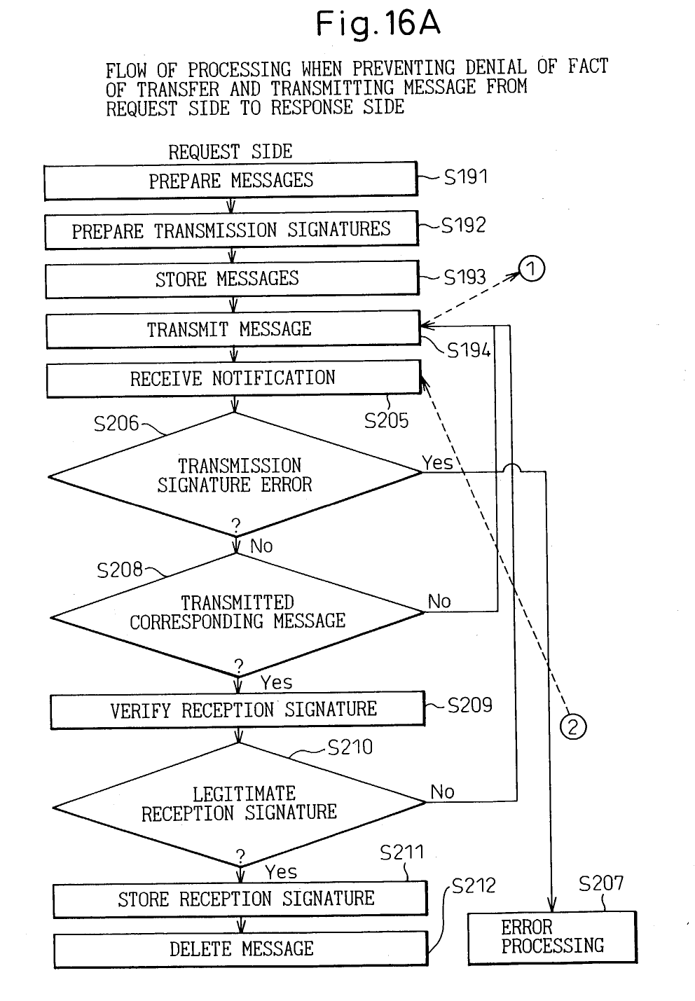

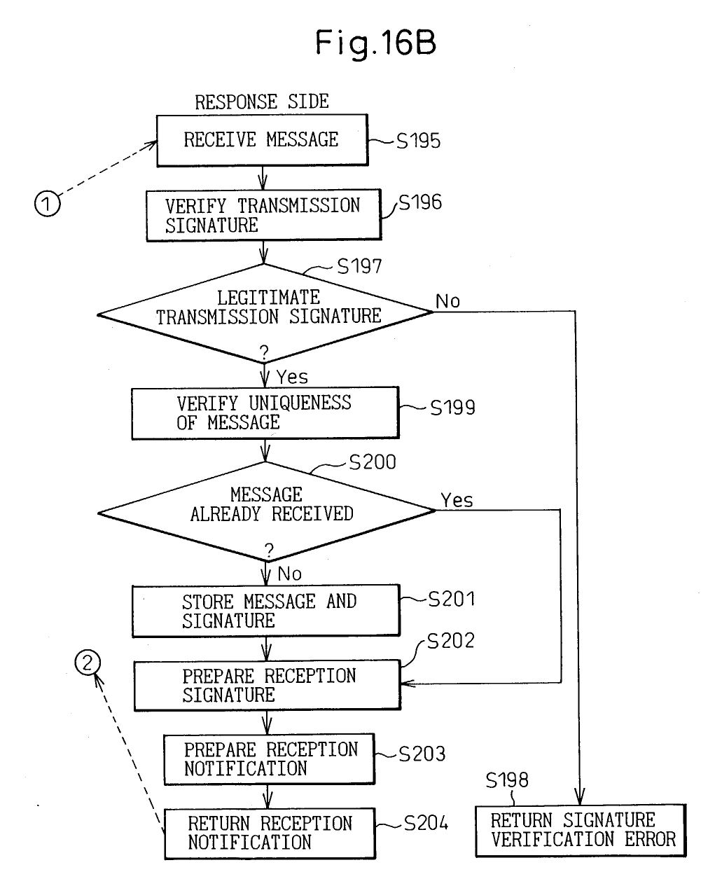

FIG. 15 is a block diagram for explaining the flow of data in the method of preventing later denial by a transferrer of the fact of transfer by the transferrer according to a seventh embodiment of the present invention, while FIGS. 16A and 16B are parts of a flow chart for explaining the flow of processing when transmitting a message from the request side 11 to the response side 12 in the system shown in FIG. 15.

FIGS. 16A and 16B are combinations of FIG. 10 and FIG. 13.

More specifically, in FIG. 15 and FIGS. 16A and 16B, the request side 11 prepares one or more messages at step S191, prepares transmission signatures able to be prepared only by a transmitter at step S192, stores the transmission signatures together with the messages at step S193, and transmits the message 21a desired to be sent to the response side 12 at step S194. The message 21a includes a request for return of a reception notification and the transmission signature.

The response side 12 receives the message at step S195 and verifies the transmission signature by the open key of the transmitter at step S196. If the result of verification is that the signature is not legitimate at step S197, the routine proceeds to step S198, where the response side 12 places a signature verification error in the reception notification 22a and returns it to the request side 11. If the result of verification of the signature is that it is legitimate at step S197, any of the methods of FIG. 6 to FIG. 8 is used to search for whether there is the same ID as the ID in the received message at the response side 12 at step S199. If the result of the search is that there is no same ID at the response side 12 at step S200, the currently received message is a new message, so the response side 12 stores the signature 90 of the transmitter together with the received message in the database 91 at step S201 and prepares a reception signature 120 able to be prepared only by a receiver at step S202. Next, it returns a reception notification 22a to the request side 11 at step S204. The reception notification 22a includes information to the effect that it is a response to a request and the reception signature.

The request side 11 monitors for reception of the reception notification 22a every predetermined time interval at step S205 and judges at step S206 whether a transmission signature error has been returned. If a transmission signature error has been returned, it performs error processing at step S207.

When the judgment at step S206 is that there is no transmission signature error, the request side 11 judges at step S208 if it has transmitted the corresponding message, that is, if the message sent from the request side 11 at step S194 has been normally received by the response side 12, by the existence of the reception notification 22a. If the reception notification 22a has not yet been received, it judges that it has not transmitted the corresponding message 21a, returns to step S194, and resends the message 21a to the response side 12.

When the judgment at step S206 is that the message 21a has finished being transmitted, the request side 11 verifies the reception signature in the reception notification 22a by the open key of the receiver at step S209. When the result of the verification is that the reception signature is not legitimate at step S210, the request side 11 judges that the message 21a has not yet been transmitted from the request side 11 to the response side 12, returns to step S194, and resends the message 21a to the response side 12.

When the verification of step S210 judges that the reception signature is legitimate, the request side 11 stores the reception signature in the database 121 at step S211, the deletes the corresponding message 21 it has stored at step S212.

Due to this, even if the request side 11 denies the fact of transmission, the database 91 of the response side 12 stores the transmission signature able to be prepared only by the request side 11, so the denial of the fact of transmission by the request side 11 can be rejected by the response side 12, while even if the response side 12 denies the fact of reception, the database 121 of the request side 11 stores the reception signal able to be prepared only by the response side 12, so the denial of the fact of reception by the response side 12 can be rejected by the request side 11.

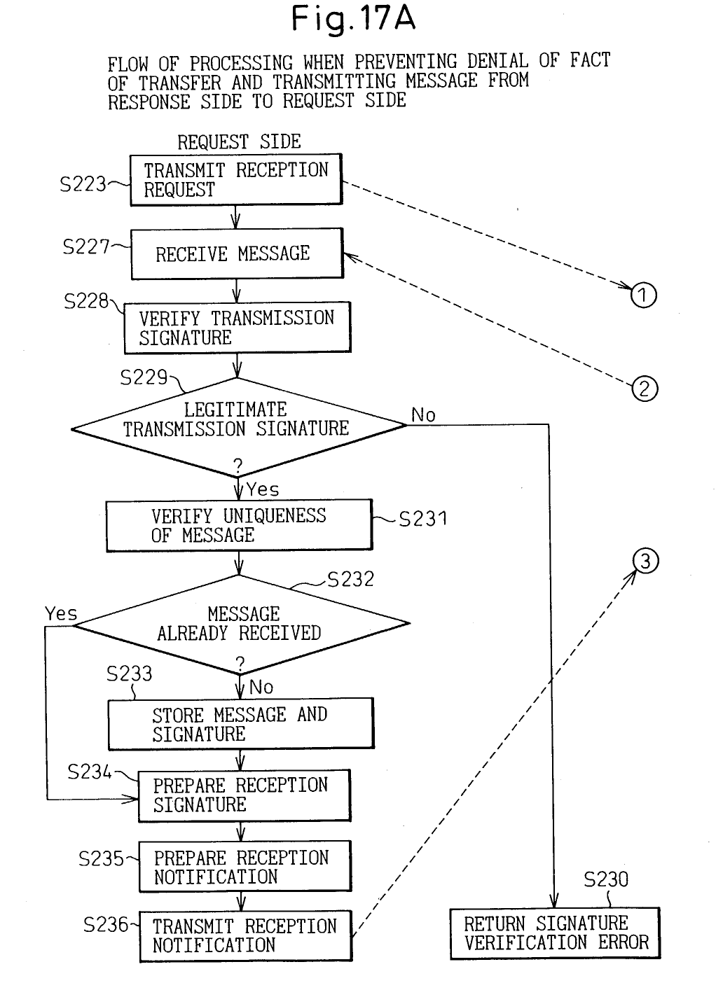

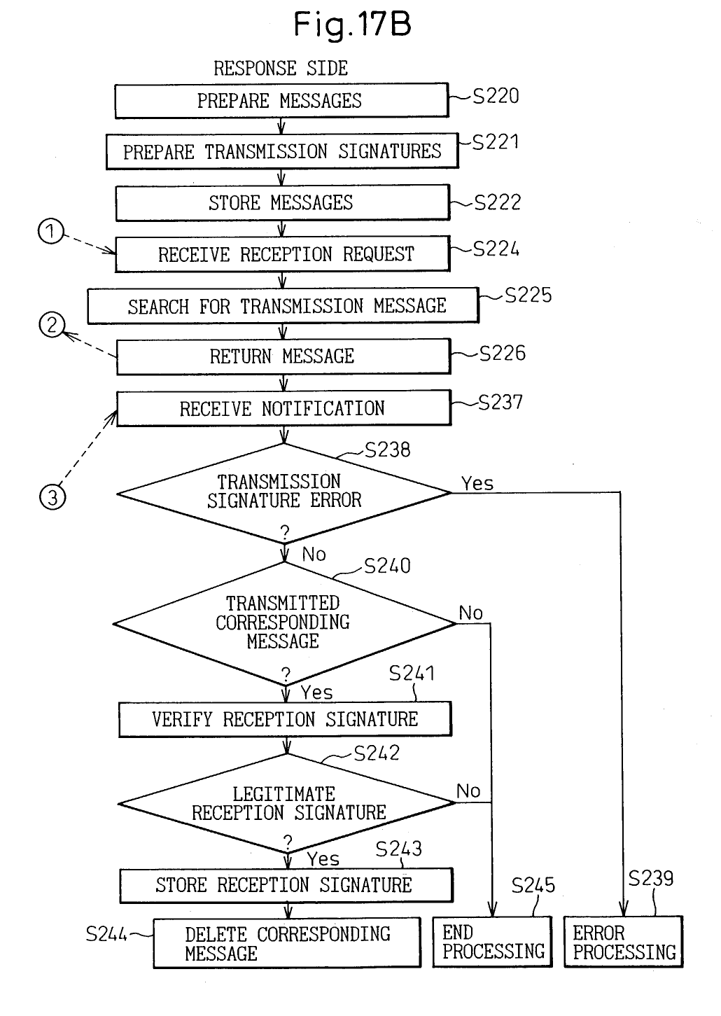

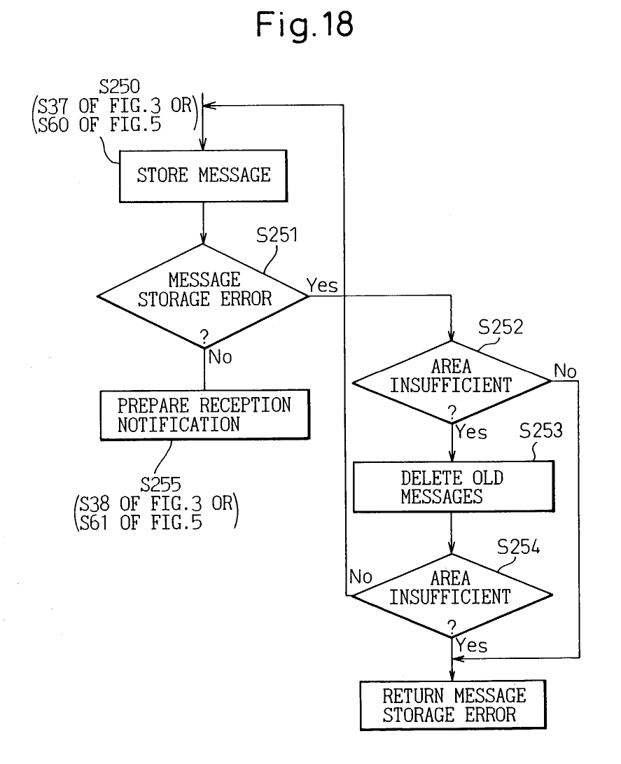

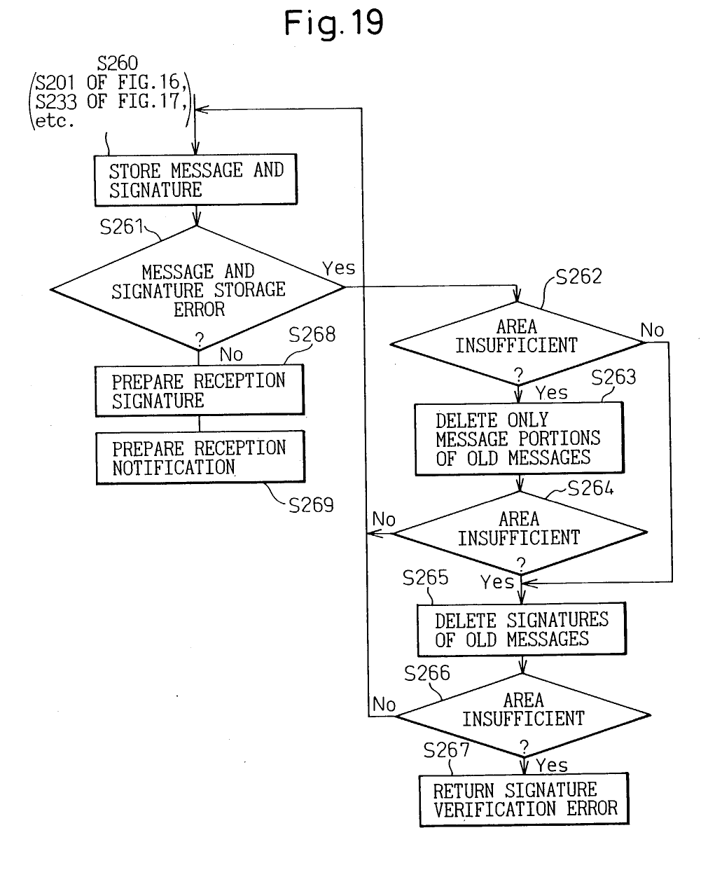

FIGS. 17A and 17B are parts of a flow chart for explaining the flow of processing for preventing denial of the fact of transfer by a transferrer when transmitting a message from the response side 12 to the request side 11 in the system shown in FIG. 15.

FIGS. 17A and 17B are combinations of FIG. 11, FIG. 14A and FIG. 14B.

More specifically, in FIG. 15 and FIGS. 17A and 17B, the response side 12 prepares one or more messages at step S220 and prepares transmission signatures able to be prepared only by the transmitters at step S221. Next, it stores the transmission signatures together with the messages at step S222.

The request side 11 transmits a reception request 41 to the response side 12 at step S223. The response side 12 receives this reception request 41 at step S224, then searches for the message 42a corresponding to this request from the stored messages at step S225. If the message 42a corresponding to the reception request is present, it transmits the message 42a including a signature 92 to the request side 11 at step S226.

The request side 11 receives this message 42a at step S227 and verifies if the transmission signature in the message received is legitimate or not by the open key of the transmitter at step S228. If not legitimate, it returns a signature verification error to the response side 12 at step S230. If legitimate, it searches for whether there is the same ID as the ID of the message 42a at the request side 11 at step S231 and step S232. If the result of the search is that there is no same ID at the response side 12, the currently received message is a new message, so the request side 11 stores the received message together with the signature 92 in the database 93 at step S233, prepares a reception signature 122 able to be prepared only by a receiver at step S234, and prepares a reception notification 43a including the reception signature 122 at step s235. Next, it transmits the reception notification 43a to the response side 12 at step S236.

If the result of the search at step S232 is that the same ID is present at the request side 11, the message has already been received, so the currently received message is not stored and the reception signature is prepared at step S235.

The response side 12 monitors for reception of the reception notification 43a every predetermined time interval at step S237 and judges at step S238 if there is a transmission signature error. If there is an error, it performs error processing at step S239. If there is no error, it judges at step S240 whether it has transmitted the corresponding message, that is, whether the message sent from the response side 12 at step S226 has been normally received by the request side 11, by the existence of the reception notification 43a. If judging that the message 42a has finished being transmitted, it verifies the reception signature by the open key of the receiver at step S241. If the signature is found to be legitimate at step S242, the response side 12 stores the reception signature 122 in the database 151 at step S243, then deletes the corresponding message 42a it has stored at step S244.

If it is judged that the corresponding message has not yet been transmitted at step S240 or if it is judged that the reception signature is not legitimate at step S242, the processing ends at step S245.

Due to this, even if the response side 12 denies the fact of transmission, the database 93 of the request side 11 stores the transmission signature able to be prepared only by the response side 12, so the denial of the fact of transmission by the response side 12 can be rejected by the request side 11, while even if the request side 11 denies the fact of reception, the database 151 of the response side 12 stores the reception signature able to be prepared only by the request side 11, so the denial of the fact of reception by the request side 11 can be rejected by the response side 12.

In the above embodiments, sometimes one or more of the received message and signature do not finish being stored normally. There are several reasons for this, for example, when there is insufficient area in the buffer for storing the message or signature, when there is no right to write in the buffer due to a write prohibit flag at the buffer, when the storage location is mistaken, or when the storage location is a database and the database is not activated. When the message or signature cannot be stored due to insufficient area in the buffer, storage becomes possible by the eighth and ninth embodiments of the present invention described below.

FIG. 18 is a flow chart for explaining the method of storage of a message according to an eighth embodiment of the present invention when a message fails to be stored at step S37 of FIG. 3 or step S60 of FIG. 5. In the figure, the operation for storing an unsigned reception message is performed at step S250. This step is the operation of step S37 in FIG. 3 or step S60 in FIG. 5. Next, at step S251, it is judged if there is a message storage error. If there is an error, the routine proceeds to step S252, where it is judged if the reason for the error is insufficient area in the message storage buffer. If insufficient area, at step S253, at least one message is deleted in the order of the oldest messages in the message storage area, then insufficiency of area is again judged at step S254. If the judgment remains that the area is insufficient, a message storage error showing that message storage has failed is returned to the transmitting side of the message. If the area is not insufficient at step S254, the routine returns to step S250, where the message is stored. If there is no message storage error at step S251, a reception notification is prepared at step S255. Step S255 corresponds to step S38 in FIG. 3 and step SS61 in FIG. 5.

The method of dealing with message storage error shown in FIG. 18 can be similarly applied to cases where message storage is not possible at step S157 in FIG. 13 or step S180 in FIG. 14A. Further, it can similarly be applied to cases where a signature received instead of a message cannot be stored. That is, when failing to store a reception signature at step S165 of FIG. 13, step S188 of FIG. 14, step S211 of FIG. 16A, and step S243 of FIG. 17B, there are cases where the signature storage error can be dealt with by a flow chart (not shown) corresponding to the flow chart shown in FIG. 18 with “message” changed to “signature”.

FIG. 19 is a flow chart for explaining the method of storage of a message and signature of a ninth embodiment of the present invention for the case where a message or signature fails to be stored at step S201 of FIG. 16B or step S233 of FIG. 17A. In the figure, an operation is performed for storing the received message and signature at step S260. This step is the operation of step S201 in FIG. 16B or step S233 in FIG. 17A. Next, at step S261, it is judged if there has been a storage error in one or more of the message and signature. If there has been an error, the routine proceeds to step S262, where it is judged if the reason for the error was insufficient area for storage of the message and signature. If the area is insufficient, at step S263, at least one message is deleted in order from the oldest messages in the storage area of the messages and signatures, then at step S264, it is judged again if the area is insufficient. If the judgment remains that the area is insufficient, at step S265, the oldest signatures in the storage area of the messages and signatures are deleted, then at step S266, it is judged again if the area is insufficient. If the judgment remains that the area is insufficient, a message showing signature verification error is sent to the transmitting side. If the area is not insufficient at step S266, the routine returns to step S260, where the message and signature are stored. If there is no storage error of the message or signature at step S261, a reception signature is prepared at step S268, then a reception notification is prepared at step S269. Step S268 and step S269 correspond to step S202 and step S203 in FIG. 16B and step S234 and step S235 at FIG. 17A.

The method of dealing with signed message storage error shown in FIG. 19 can similarly be applied to step S111 in FIG. 10, step S134 in FIG. 11, and step S201 in FIG. 16B.

In this way, even when insufficient capacity of the buffer would result in failure of storage of the received message or signature, the received message or signature can be reliably stored by deleting the old messages or signatures from the buffer.

An example of the format of a message used in the embodiments described above will be given next. In the following example, the message is prepared based on the standard of SOAP by the Extensible Markup Language (XML) defining communication protocol among applications.

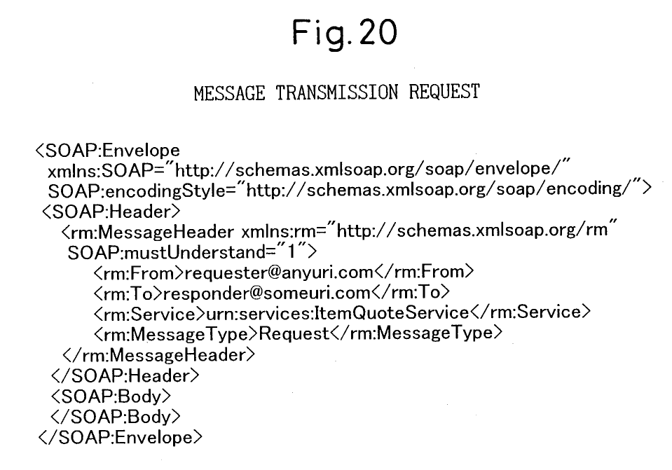

FIG. 20 is an example of the content of a message when requesting transmission of a message from the request side to the response side. In this message, the “request” showing the transmission request is described as the “message type” in the header. This message is used at step S53 of FIG. 5, step S124 of FIG. 11, step S173 of FIG. 14, and step S223 of FIG. 17. In FIG. 20, in the information between <SOAP:Envelope and </SOAP:ENVELOPE>, the smls:SOAP= . . . given at the first line indicates that message is described by the XML format based on the SOAP standard.

The portion between the <rm:Message Header . . . and </rm:Message Header> between <SOAP:Header> and </SOAP:Header> is the header of the message. The message header describes the source of transmission of the message, the destination of transmission, the type of service of the message, and the type of message. In this example, the source of transmission is requester@anyuri.com, that is, the request side, as described at the line beginning at <rm:From>. Further, the destination of transmission is responder@someeuri.com, that is, the response side, as described in the line beginning <rm:To>. Further, the type of the service is an inquiry service as described by the Item Quote Service” at the line beginning <rm:Service>. Further, the type of the message is a request message as described by “Request” at the line beginning <rm:Message Type>.

Since the transmission request for the message does not include information of the message itself, nothing is described between <SOAP:Body> and </SOAP:Body>.

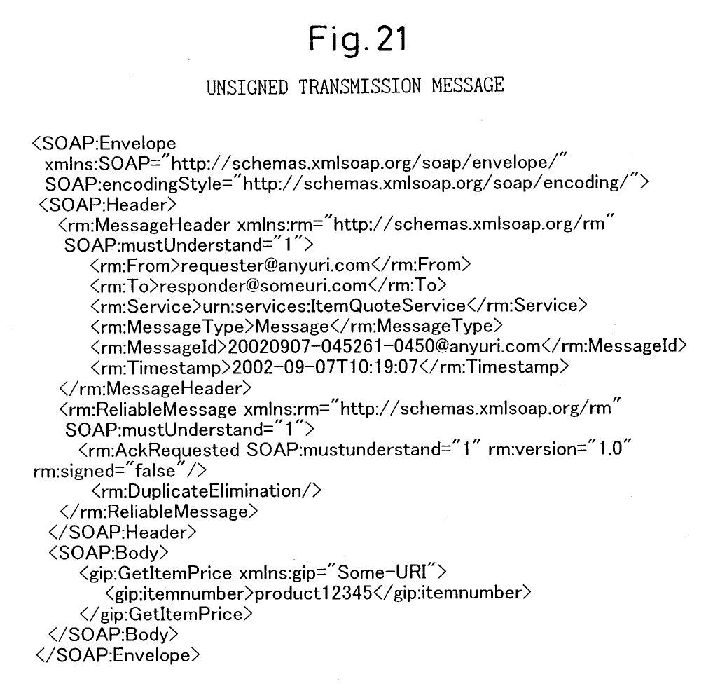

FIG. 21 is a view of an example of an unsigned transmission message. This message is used for message transmission from the request side at step S33 of FIG. 3. In the figure, in the information between <SOAP:Envelope and </SOAP:ENVELOPE>, the first line is the same as in FIG. 20. Further, the source of transmission, destination of transmission, and type of service in the header between <rm:Message Header . . . > and </Message Header> are the same as in the example of FIG. 20. In addition, the type of message, message ID, transmission date, etc. are described. The type of message is a message as described by “message” in the line beginning <rm:Message Type>. Further, 20020907-045261-0450@anyuri.com is described in the line of <rm:Message Id> as the message ID. Further, 2002-09-07T10:19:07 is described in the line of <rm:Timestamp> as the transmission time.

The header between <rm:Reliable Message . . . > and </rm:Reliable Message> contains information for ensuring the reliability of the transmission message. That is, <rm:AckRequested SOAP:must understand . . . describes that the format of the acknowledgment message should comply with the SOAP standard. Further, <rm:Duplicate Elimination/> is for deleting a duplicately received message.

The portion between <SOAP:BODY> and </SOAP:BODY> carries the content of the information depending on the application.

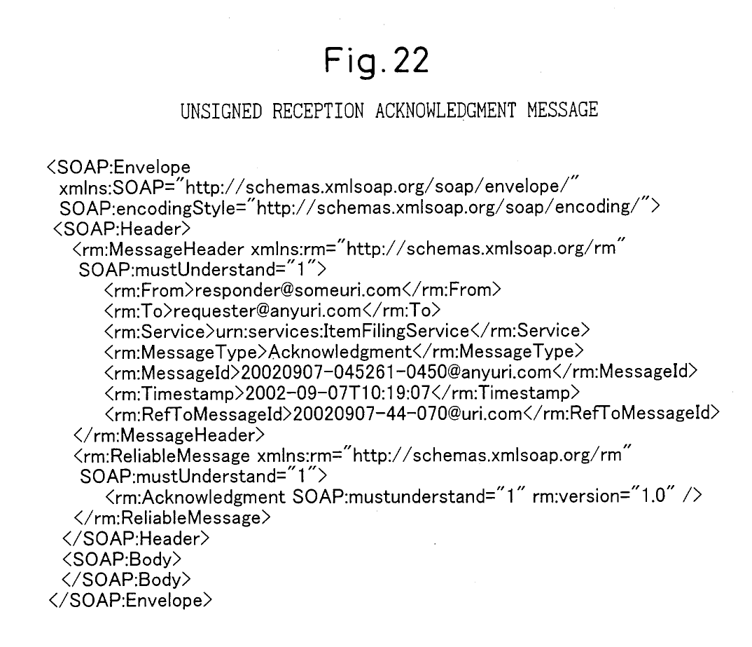

The message transmitted at step S56 in FIG. 5 is prepared by a similar format as in FIG. 22 with just the source of transmission and the destination of transmission reversed from those shown in FIG. 22.

FIG. 22 is a view of an example of an unsigned reception acknowledgment message. This message is used at step S39 of FIG. 3. The format of the message is similar to that shown in FIG. 21, so a detailed explanation will be omitted. The fact that the type of the service is an “Item Filing Service”, that is, a file through service, and that the type of the message is an “Acknowledgment”, that is, acknowledgment message, should be noted. In this example, the source of transmission is the response side, while the destination of transmission is the request side, but if the source of transmission is made the request side and the destination of transmission is made the response side, the result will be the message used at step S62 of FIG. 5.

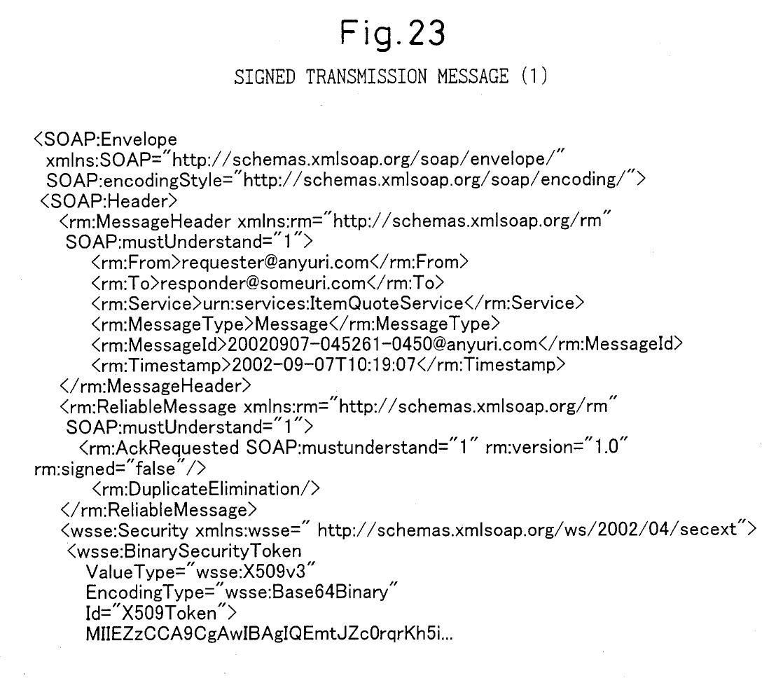

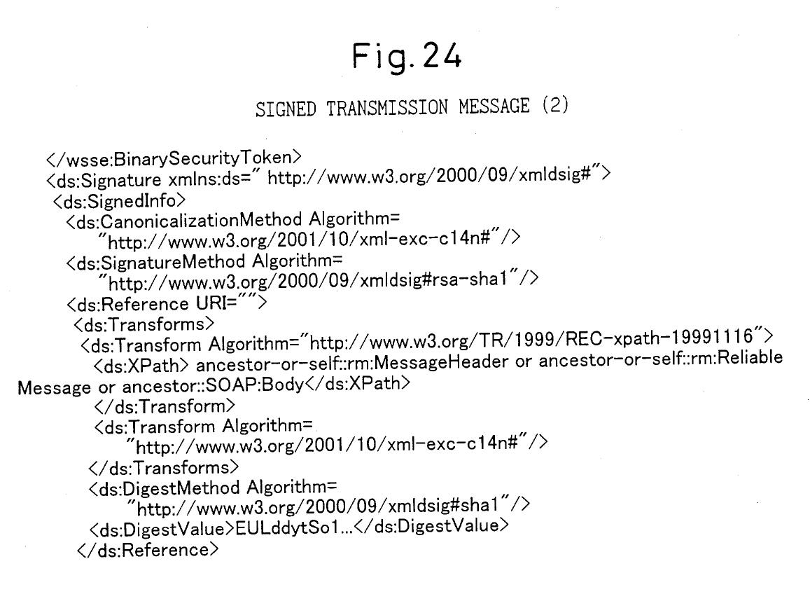

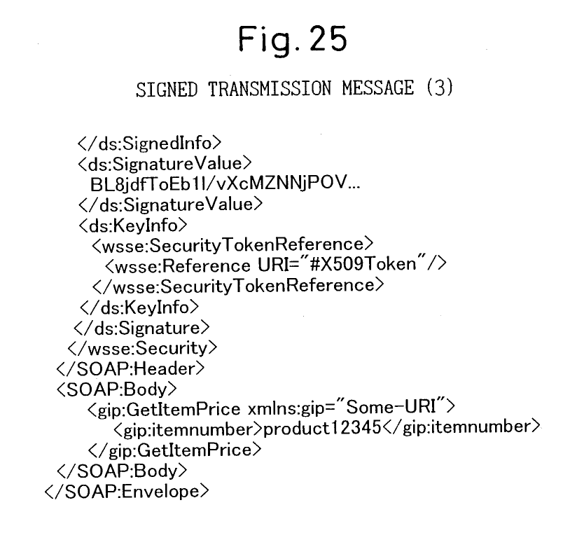

FIG. 23 to FIG. 25 are views of an example of a signed transmission message. This message is used at step S104 of FIG. 10. In this message, the portion from <SOAP:Envelope> of the first line to </rm:Reliable Message> of the 19th line is the same as in the unsigned transmission message shown in FIG. 21. In this example, there is a tag between <wsse:Security xmls:wsse=” to </wsse:BinarySecurity Token> at the next line. Here, security is ensured by the Web Service Security (wsse).

The portion from the next tag <ds:Signature xmls . . . to </ds:SignatureValue> describes the signature by the XML format. The signature covers the message header, the Reliable Message, and the SOAP Body as described in the tag of <ds:Xpath>. Due to this, tampering with the message header, Reliable Message, and SOAP Body can be prevented.

In this way, it is possible to prevent denial by the transmitter due to attachment of a signature of the WS-Security format to the transmission message.

In this example as well, if the source of transmission is made the response side and the destination of transmission is made the request side, the message becomes one used at step S126 of FIG. 11.

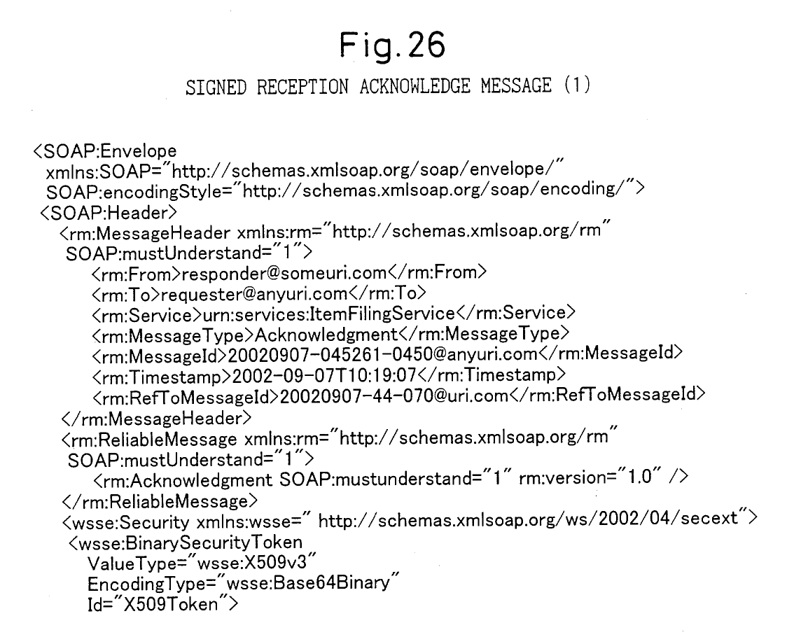

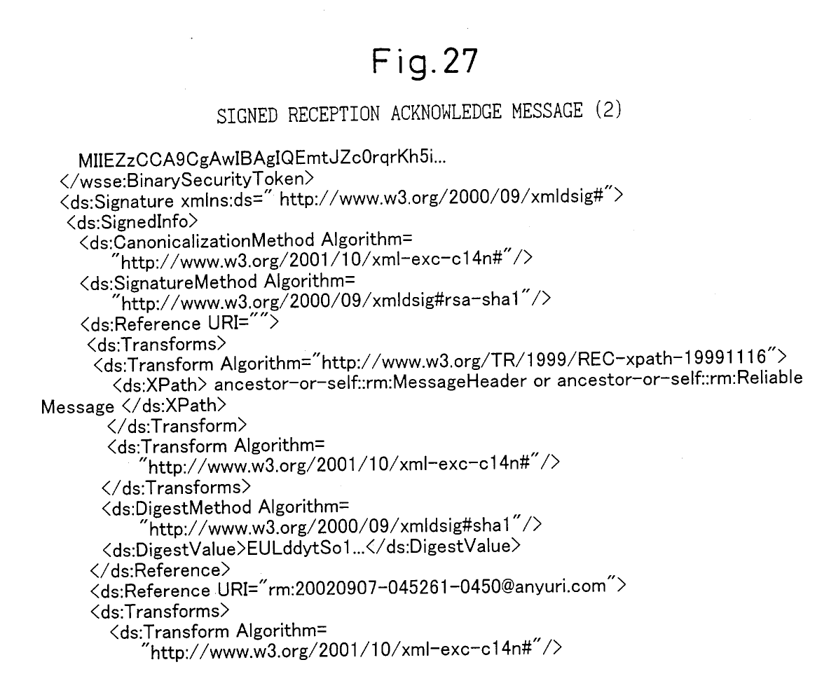

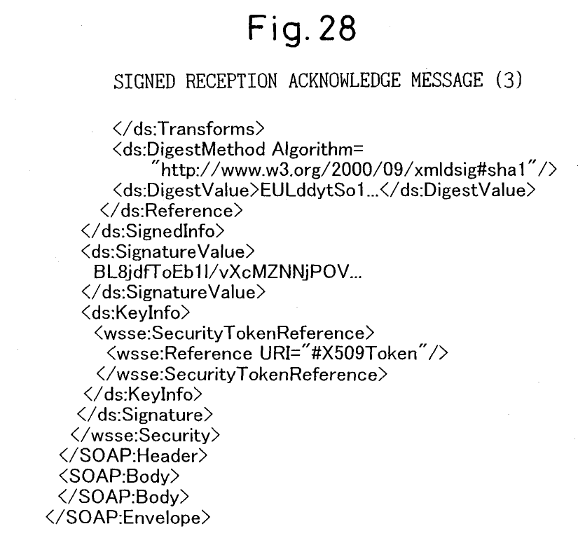

FIG. 26 to FIG. 28 show an example of a signed reception acknowledgment message. This message is used at step S113 of FIG. 10, step S160 of FIG. 13, and step S204 of FIG. 16. The format of the message is similar to that shown in FIG. 23 to FIG. 25, so a detailed explanation will be omitted. The fact that the type of the service is an “Item Filing Service”, that is, a file through service, and that the type of the message is an “Acknowledgment”, that is, acknowledgment message, should be noted. In this example as well, by affixing a signature of the WS-Security format to the reception acknowledgment message, tampering with the message header, Reliable Message, and SOAP Body can be prevented.

In this example as well, if the source of transmission is made the request side and the destination of transmission is made the response side, the message becomes one used at step S136 of FIG. 11, step S183 of FIG. 14, and step S236 of FIG. 17.

As explained above, according to the present invention, the effect is obtained that two-way acknowledgment of transmission can be realized by using a one-way request/response type communication protocol.

Further, by preparing signatures for the transferred messages and exchanging these, the effect is obtained that the fact of transfer is left as proof and therefore denial of the fact of transmission or the fact of reception can be prevented.

Further, by using XML to construct the message, the effect is obtained that it is possible to facilitate automation of the processing for verifying the uniqueness of the message.

Further, even when the received message cannot be stored due to insufficient capacity of the buffer, there is the advantage that this problem can be dealt with by deleting old messages and old signatures.

What is claimed is:

1. A two-way communication method in a system using only request/response type synchronous communication consisting of a request side making a one-way request to a response side and said response side responding to said request to said request side, comprising:
transmitting a message from said request side to said response side by continuing to transmit the same message transmitted to said response side until said response side replies to said request side that it has received the message and
transmitting a message from said response side to said request side by having said request side request reception of a message and having said response side continue to transmit the same message to said request side until said request side notifies the response side that it has received the message by new communication to thereby
enable two-way transfer of messages.

2. A two-way communication method as set forth in claim 1, further comprising adding a unique identifier inside a transmission message and checking for duplication at the receiving side so as to prevent the same message from being received in duplicate.

3. A two-way communication method as set forth in claim 2, further comprising using XML for the format of said message and adding said identifier inside the message at a specific name space different from said message so as to prevent the same message from being received in duplicate without changing the format of the message.

4. A two-way communication method as set forth in claim 1, further comprising realizing the uniqueness of said message by any form and verifying the uniqueness of the message by using a digest value of said message so as to prevent the same message from being received in duplicate.

5. A two-way communication method as set forth in claim 1, further comprising storing a received message in a buffer, then notifying the message transmitting side of the reception of the message and, when insufficient capacity of said buffer would result in said received message failing to be stored, deleting old messages in said buffer to enable said received message to be stored in said buffer.

6. A two-way communication method as set forth in any one of claims 2 to 4, further comprising employing at least one of the techniques of:
adding a transmission message use electronic signature to a message transmitted by a transmitting side of the message and having said receiving side store said transmission message use electronic signature so as to enable denial of the fact of transmission by said transmitting side to be prevented and
adding a reception notification use electronic signature to a message reception notification transmitted by a receiving side of a message in response to reception of said message and having said transmitting side store said reception notification use electronic signature so as to enable denial of the fact of reception by said receiving side to be prevented.

7. A two-way communication method as set forth in claim 6, further comprising storing said signed received message in a buffer of the receiving side, then notifying the message transmitting side of the reception of the message and, when insufficient capacity of said buffer would result in at least one of said received message and signature failing to be stored, deleting old messages in said buffer, then, when the capacity of said buffer would remain insufficient, deleting old signatures in said buffer to enable said signed received message to be stored in said buffer.
